(19) United States
(12) Patent Application Publication
(10) Pub. No.: US 2013/0027188 A1
(43) Pub. Date: Jan. 31, 2013

(54) INTERROGATOR APPARATUS, COMMUNICATION METHOD, AND COMMUNICATION PROGRAM

(71) Applicant: Takahiro Shimura, Shizuoka (JP)

(72) Inventor: Takahiro Shimura, Shizuoka (JP)

(73) Assignee: TOSHIBA TEC KABUSHIKI KAISHA, Tokyo (JP)

(21) Appl. No.: 13/548,290

(22) Filed: Jul. 13, 2012

(30) Foreign Application Priority Data
Jul. 29, 2011 (JP) 2011-167127

(51) Int. Cl. G06K 7/01

(52) U.S. Cl. 340/10.2; 340/10.1

(57) ABSTRACT

According to one embodiment, an interrogator apparatus includes a transmitting section configured to generate a transmission signal, a receiving section configured to process a reception signal, an antenna configured to transmit and receive a radio signal, a directional coupler configured to supply the transmission signal from the transmitting section to the antenna and supply the reception signal from the antenna to the receiving section, a switching element, a first terminal of which is connected to the directional coupler and a second terminal of which is grounded, the switching element connecting the first terminal or the second terminal to the antenna according to a control signal, and a control section configured to control, when performing carrier sense and detecting a carrier, the switching element to back-scatter an interrupt signal and stop transmission of a radio signal to another interrogator apparatus having a lower priority degree than the interrogator apparatus.

### CROSS-REFERENCE TO RELATED APPLICATIONS

This application is based upon and claims the benefit of priority from the prior Japanese Patent Application No. 2011-167127, filed on Jul. 29th, 2011, and the entire contents of which are incorporated herein by reference.

### FIELD

Embodiments described herein relate generally to an interrogator apparatus, a communication method, and a communication program.

### BACKGROUND

A radio tag, which is an information storage medium communicable by radio, is also called RFID (Radio Frequency Identification). A system that transmits and receives information to and from an interrogator is put to practical use.

A passive tag, which is a type of the radio tag, is not mounted with a battery. This radio tag generates electric power from a radio signal from the interrogator and performs communication with the interrogator. The electric power of the radio signal from the interrogator is large because the electric power needs to be supplied to the radio tag.

Therefore, if plural interrogators are used in close proximity to one another, in some cases, interference of radio signals occurs and reading performance of the radio tag is deteriorated. In particular, if it is necessary to preferentially use a specific interrogator among the plural interrogators, the interference of the radio signals substantially hinders job performance.

In this regard, several techniques are proposed. As a first technique, a carrier sense system is proposed. The carrier sense system is a system for detecting a radio signal from another interrogator and, if a radio signal is detected, not starting communication with a radio tag and, if an unused channel in a no-signal state is present, starting communication with the radio tag using the channel.

However, in this system, an interrogator that starts communication earlier monopolizes a channel for a while and an interrogator desired to be preferentially used has to be put on standby during this period. If plural interrogators simultaneously transmit radio signals using different channels, the radio tag may be unable to normally receive the radio signals.

As a second technique, a technique for controlling plural interrogators using a control device is proposed. The control device manages the plural interrogators in a time division manner to prevent the plural interrogators from simultaneously performing radio communication.

However, in this technique, the control device is needed anew and a system is complicated.

Therefore, there is a demand for an interrogator apparatus, a communication method, and a communication program that do not cause interference of radio signals even if plural interrogators are simultaneously operated and can allow an interrogator desired to be preferentially used to perform radio communication in preference to the other interrogators.

### BRIEF DESCRIPTION OF THE DRAWINGS

FIG. 1A is a configuration diagram of an interrogator apparatus;

FIG. 1B is a configuration diagram of an interrogator apparatus in which an FET is used as a switching element;

FIG. 2 is a diagram of an example of a communication operation of the interrogator apparatus;

FIGS. 3A and 3B are diagrams for explaining a relation between the operation of the switching element and a back scatter signal;

FIG. 4 is a diagram of the structure of a priority degree table;

FIG. 5 is a diagram of a first example of an interrupt signal transmitted by the interrogator apparatus using back scatter;

FIG. 6 is a diagram of an example of the structure of Preamble;

FIG. 7 is a diagram of a second example of the interrupt signal transmitted by the interrogator apparatus using the back scatter;

FIGS. 8A and 8B are timing charts for explaining an example in which an interrogator apparatus having a high priority degree is given priority according to an interrupt signal;

FIGS. 9A and 9B are timing charts for explaining an example in which an interrogator apparatus having a low priority degree is neglected according to the interrupt signal;

FIG. 10 is a flowchart for explaining the operation of transmission determination processing by the interrogator apparatus;

FIG. 11 is a flowchart for explaining the operation of communication continuation determination processing by the interrogator apparatus;

FIG. 12 is a diagram of a first example of a priority signal transmitted by the interrogator apparatus according to an AM modulation signal;

FIG. 13 is a diagram of an example of a stop signal transmitted by the interrogator apparatus using back scatter;

FIG. 14 is a diagram of a second example of the priority signal transmitted by the interrogator apparatus according to the AM modulation signal;

FIGS. 15A and 15B are timing charts for explaining an example in which an interrogator apparatus having a high priority degree is given priority according to a priority signal and a stop signal;

FIGS. 16A and 16B are timing charts for explaining an example in which an interrogator apparatus having a low priority degree is silenced according to the priority signal and the stop signal;

FIG. 17 is a flowchart for explaining the operation of transmission determination processing by the interrogator apparatus; and

FIG. 18 is a flowchart for explaining the operation of communication continuation determination processing by the interrogator apparatus.

### DETAILED DESCRIPTION

Throughout this description, the embodiments and examples shown should be considered as exemplars, rather than limitations on the apparatus and methods of the present invention.

An interrogator apparatus, a communication method, and a communication program according to an embodiment are explained in detail below with reference to the drawings.

The interrogator apparatus according to this embodiment includes: a transmitting section configured to generate a transmission signal; a receiving section configured to process a reception signal; an antenna configured to transmit and receive a radio signal; a directional coupler configured to supply the transmission signal from the transmitting section to the antenna and supply the reception signal from the antenna to the receiving section; and a switching element, a first terminal of which is connected to the directional coupler and a second terminal of which is grounded, the switching element switching, according to a control signal, whether the antenna is ground.

The communication method according to this embodiment is a communication method for an interrogator apparatus including: controlling a switching element of the interrogator apparatus to back-scatter a radio signal from another interrogator apparatus by switching the switching element according to a control signal, whether the antenna is grounded.

The communication program according to this embodiment is a communication program for an interrogator apparatus including: a transmitting section configured to generate a transmission signal; a receiving section configured to process a reception signal; an antenna configured to transmit and receive a radio signal; a directional coupler configured to supply the transmission signal from the transmitting section to the antenna and supply the reception signal from the antenna to the receiving section; and a switching element, a first terminal of which is connected to the directional coupler and a second terminal of which is grounded, the switching element switching, according to a control signal, whether the antenna is ground, the program including controlling the switching element of the interrogator apparatus to back-scatter a radio signal from another interrogator apparatus.

### Interrogator Apparatus

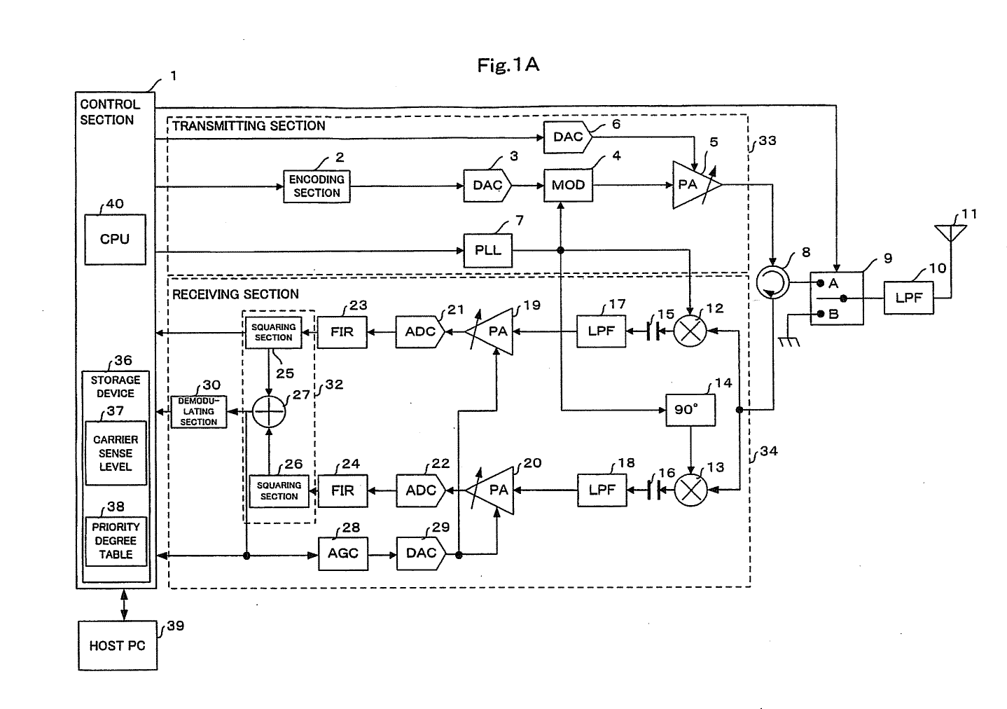

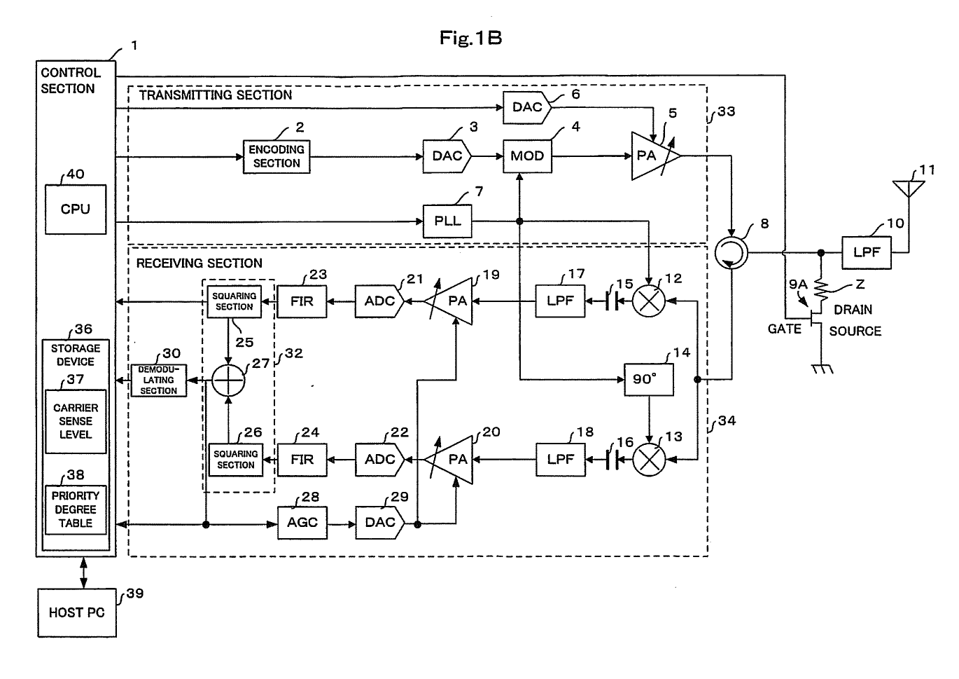

FIG. 1A is a configuration diagram of the interrogator apparatus according to this embodiment. As shown in FIG. 1A, the interrogator apparatus includes a control section 1 configured to generate a control signal and subject information to arithmetic processing, a transmitting section 33 configured to generate a transmission signal, a receiving section 34 configured to process a reception signal, an antenna 11 configured to transmit and receive a radio signal, a directional coupler 8 configured to supply the transmission signal from the transmitting section 33 to the antenna 11 and supply the reception signal from the antenna 11 to the receiving section 34, and a switching element 9, a first terminal A of which is connected to the directional coupler 8 and a second terminal B of which is grounded, the switching element 9 connecting the first terminal A or the second terminal B to the antenna 11 according to the control signal from the control section 1.

The control section 1 includes a CPU 40, which is an arithmetic unit, and a storage device 36 configured to store information. The storage device 36 stores a carrier sense level 37, which is a threshold of carrier sense, and a priority degree table 38 including priority degrees indicating the priority order of interrogators. The control section 1 is connected to a host PC 39, which is a host apparatus, via an interface.

The transmitting section 33 includes an encoding section 2 configured to encode a transmission signal, a modulating section (MOD) 4 configured to modulate the encoded transmission signal, and an amplifier (PA) 5 configured to amplify the modulated transmission signal.

The control section 1 outputs a transmission signal to the encoding section 2. The encoding section 2 digitally encodes the transmission signal with, for example, a PIE (Pulse Interval Encoding) code. A digital-analog converter (DAC) 3 converts the encoded transmission signal into an analog signal.

The control section 1 controls a PLL 7 to generate a local signal. The modulating section 4 modulates the transmission signal using the local signal and outputs the modulated transmission signal to the amplifier 5.

The control section 1 outputs an amplification ratio to a digital-analog converter (DAC) 6. The amplifier 5 amplifies the transmission signal on the basis of the amplification ratio converted into an analog signal and outputs the amplified transmission signal to the directional coupler 8.

The receiving section 34 includes a first converting section configured to amplify a reception signal and convert the reception signal into a digital signal, a second converting section configured to amplify the reception signal while shifting a phase of the reception signal 90° with respect to the signal of the first converting section and convert the reception signal into a digital signal, a response-signal-intensity measuring section 32 configured to raise an output signal of the first converting section to the second power, raise an output signal of the second converting section to the second power, and add up the signals raised to the second power, and a demodulating section 30 configured to demodulate an output signal of the response-signal-intensity measuring section 32 and output the output signal to the control section 1.

A low-pass filter (LPF) 10 removes a high-frequency component from a radio signal received by the antenna 11 and outputs the radio signal to the directional coupler 8 via the first terminal A of the switching element 9.

The first converting section integrates a reception signal input from the directional coupler 8 and the local signal of the PLL 7 using an integrator 12, removes a direct-current component using a capacitor 15, removes an unnecessary high-frequency component using a low-pass filter (LPF) 17, and outputs an integrated signal to an amplifier (PA) 19. The first converting section further amplifies the signal using the amplifier 19, converts the signal into a digital signal using an analog-digital converter (ADC) 21, and filters an unnecessary component using a digital filter (FIR) 23.

The second converting section integrates the reception signal input from the directional coupler 8 and the local signal of the PLL 7, a phase of which is shifted 90° by a phase shifter (90°) 14, using an integrator 13, removes a direct-current component using a capacitor 16, removes an unnecessary high-frequency component using a low-pass filter (LPF) 18, and outputs an integrated signal to an amplifier (PA) 20. The second converting section further amplifies the signal using the amplifier 20, converts the signal into a digital signal using an analog-digital converter (ADC) 22, and filters an unnecessary component using a digital filter (FIR) 24.

The response-signal-intensity measuring section 32 raises the output from the first converting section to the second power using a first squaring section 25, raises the output from the second converting section to the second power using a second squaring section 26, adds up the signals raised to the second power using an adder 27, and outputs an added-up signal to the demodulating section 30.

The demodulating section 30 demodulates the output signal from the adder 27 according to a modulation system for a response signal of a radio tag and outputs the modulated signal to the control section 1.

The response-signal-intensity measuring section 32 outputs the output from the adder 27 to the control section 1 and an AGC circuit (AGC) 28. If the amplitude of the input signal is lower than a threshold, the AGC circuit 28 outputs a signal for increasing a gain of the amplifier 20. A digital-analog converter (DAC) 29 converts the signal into an analog signal and outputs the analog signal to the amplifier 20.

The switching element 9 is explained. The switching element 9 is a high-frequency switch such as an SPDT (Single pole, Dual throw) switch. As the SPDT switch, a publicly-known SPDT switch can be adopted. The configuration and operation of the SPDT switch is disclosed in, for example, JP-A-2001-237682. The switching element 9 switches the first terminal A and the second terminal B according to a signal from the control section 1.

The switching element 9 is usually connected to the first terminal A. The antenna 11 functions as an antenna and reflection on the antenna 11 is little. When a radio wave is transmitted from the interrogator apparatus, an output of the PA 5 is input to the antenna 11 via the directional coupler 8, the switching element 9, and the LPF 10. A radio wave is output from the antenna 11. During reception, a high-frequency signal received by the antenna 11 can be received as data through the directional coupler 8, the receiving section 34, and the control section 1.

When the switching element 9 is connected to the second terminal B, since the first terminal B is grounded, the antenna 11 does not function as an antenna and the high-frequency signal is reflected by the antenna 11.

Therefore, the control section 1 subjects the switching element 9 to switching control, whereby the interrogator apparatus can back-scatter and transmit an unmodulated signal from another interrogator apparatus.

FIG. 1B is a configuration diagram of an interrogator apparatus in which an FET is used as the switching element. As shown in FIG. 1B, an FET (Field Effect Transistor) 9A can be adopted as the switching element 9 shown in FIG. 1A.

In this case, a drain terminal of the FET 9A is connected, via a resistor Z, to a line that connects the LPF 10 and the directional coupler 8. A control signal from the control section 1 is input to a gate terminal of the FET 9A. A source terminal of the FET 9A is grounded.

In the case of an N-channel FET, if a signal from the control section 1 is low, the FET 9A is turned off, the FET 9A is open between the drain and the source, the antenna 11 functions as an antenna, and reflection on the antenna 11 is little.

If the signal from the control section 1 is high, the FET 9A is turned on, the FET 9A is in a conduction state between the drain and the source, and the antenna 11 is grounded via the resistor Z, does not function as an antenna, and reflects an unmodulated signal from another interrogator apparatus. The impedance of the resistor Z only has to be a value that causes mismatch of the antenna 11. The impedance may be z=0 (short circuit).

Therefore, it is possible to back-scatter the unmodulated signal by switching high and low of the signal input to the FET 9A.

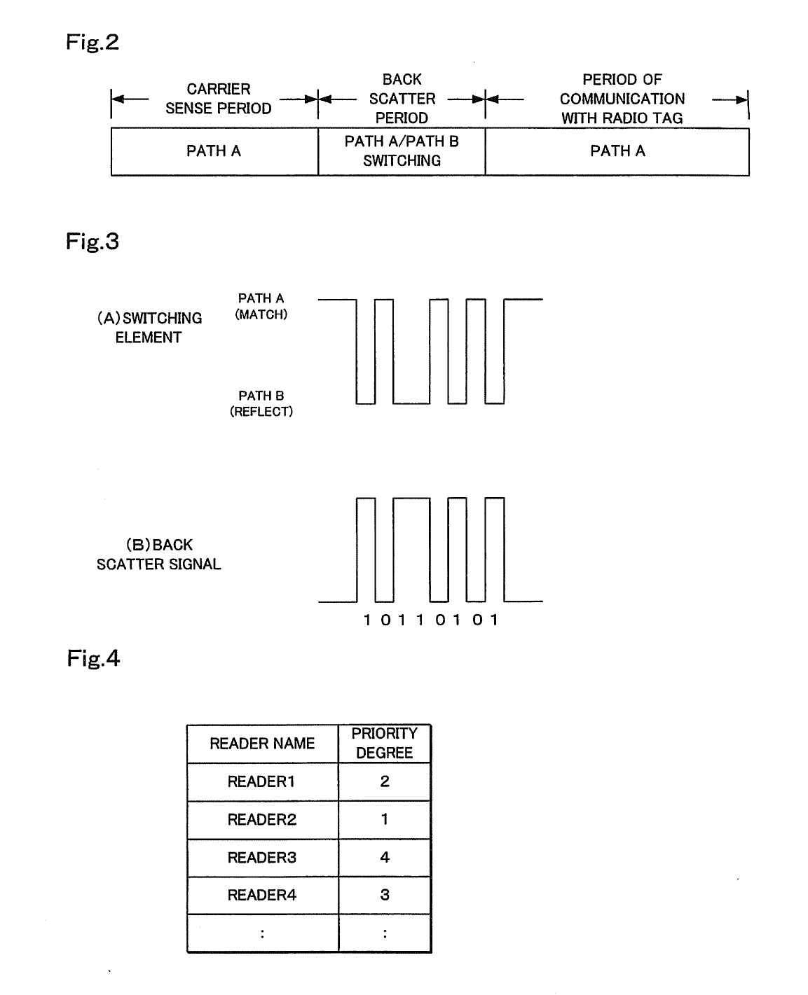

FIG. 2 is a diagram of an example of a communication operation of the interrogator apparatus. As shown in FIG. 2, the interrogator apparatus connects the first terminal A of the switching element 9 to forma path A and performs carrier sense in a carrier sense period.

If the interrogator apparatus detects a radio signal from another interrogator apparatus as a result of the carrier sense, in a back-scatter period, the interrogator apparatus controls the switching element 9 to switch, according to data to be transmitted, the path A and a path B formed by connecting the switching element 9 to the second terminal B. A back-scatter signal is transmitted to the other interrogator apparatus by the switching.

In a period of communication with the radio tag, the interrogator apparatus controls the switching element 9 to form the path A and performs communication with the radio tag.

FIGS. 3A and 3B are diagrams for explaining a relation between the operation of the switching element 9 and a back scatter signal. As shown in FIGS. 3A and 3B, if the switching element 9 shown in FIG. 3A forms the path A, an unmodulated signal is not reflected and, if the switching element 9 forms the path B, the unmodulated signal is reflected.

Therefore, the back-scatter signal shown in FIG. 3B is “0” in the case of the path A and is “1” in the case of the path B.

FIG. 4 is a diagram of the structure of the priority degree table 38. As shown in FIG. 4, the priority degree table 38 stores “reader name”, which is a name peculiarly allocated to each interrogator apparatus and “priority degree” representing priority order.

As an example of data of the items, “reader name” is “reader 1” and “priority degree” is “2”.

### Communication Method

### FIRST EMBODIMENT

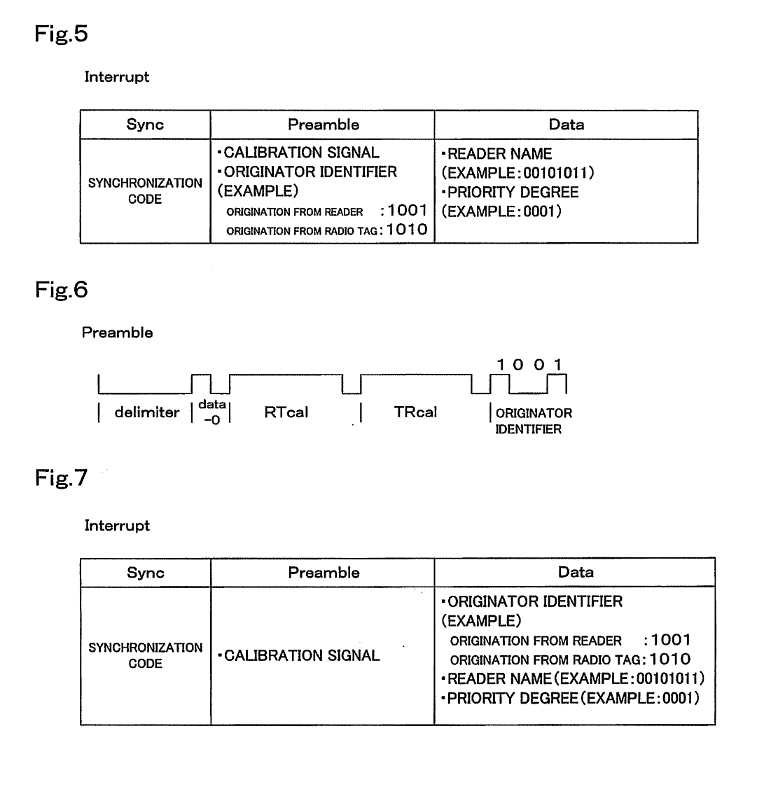

FIG. 5 is a diagram of a first example of an interrupt signal transmitted by the interrogator apparatus using back scatter.

As shown in FIG. 5, an interrupt signal Interrupt includes Sync, Preamble, and Data.

Sync is a synchronization code. Preamble includes a calibration signal and an originator identifier for identifying an originator of a signal.

The originator identifier indicates whether a received back-scatter signal is a signal from the radio tag or a signal from another interrogator apparatus. For example, if a signal is originated from the interrogator apparatus, “1001” indicating “origination from a reader” can be adopted as the originator identifier. If a signal is originated from the radio tag, “1010” indicating “origination from the radio tag” can be adopted as the originator identifier.

According to the originator identifier, if a received signal is a signal from the radio tag, the interrogator apparatus can perform normal radio communication and, if the received signal is a signal from another interrogator apparatus, the interrogator apparatus can recognize that the signal is an interrupt signal.

Data includes “reader name” indicating an originator interrogator apparatus and “priority degree” indicating a priority degree of the originator interrogator apparatus.

FIG. 6 is a diagram of an example of the structure of Preamble. As shown in FIG. 6, Preamble includes delimiter indicating the start of a signal, data-0 for calibrating data length, RTcal for calibration of a radio signal from the interrogator apparatus to the radio tag, TRcal for calibration of a radio signal from the radio tag to the interrogator apparatus, and an originator identifier.

In the example shown in FIG. 6, the originator identifier indicates that a signal is a signal originated from the interrogator apparatus.

FIG. 7 is a diagram of a second example of the interrupt signal transmitted by the interrogator apparatus using the back scatter.

As shown in FIG. 7, the interrupt signal Interrupt includes Sync, Preamble, and Data.

Sync is a synchronization code. Preamble includes a calibration signal.

Data includes an originator identifier for identifying an originator of a signal, “reader name” indicating an originator interrogator apparatus, and “priority degree” indicating a priority degree of the originator interrogator apparatus.

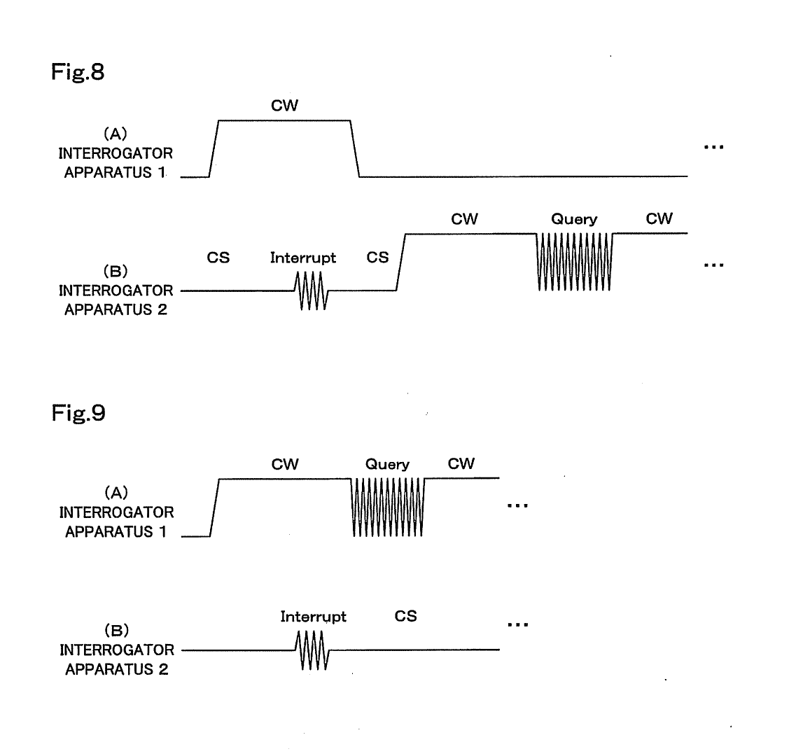

FIGS. 8A and 8B are timing charts for explaining an example in which an interrogator apparatus having a high priority degree is given priority according to an interrupt signal. In this example, operation performed when an interrogator apparatus 2 has a higher priority degree than an interrogator apparatus 1 is explained.

As shown in FIG. 8A and 8B, the interrogator apparatus 1 originates an unmodulated signal (CW). The interrogator apparatus 2 detects a carrier when the interrogator apparatus 2 performs carrier sense (CS). Therefore, the interrogator apparatus 2 may be unable to transmit a radio signal to the radio tag. This is because interference occurs if the interrogator apparatus 2 transmits a radio signal.

Therefore, the interrogator apparatus 2 back-scatters the interrupt signal Interrupt by controlling the switching element 9.

The interrogator apparatus 1 compares a priority degree in Interrupt and a priority degree of the interrogator apparatus 1 stored in the priority degree table 38. If the priority degree of the interrogator apparatus 1 is lower than the priority degree in Interrupt, the interrogator apparatus 1 stops transmission of a radio signal.

The interrogator apparatus 2 performs the carrier sense again after transmitting Interrupt. If the interrogator apparatus 2 determines that the radio signal is stopped, the interrogator apparatus 2 transmits Query and starts communication with the radio tag.

FIGS. 9A and 9B are timing charts for explaining an example in which an interrogator apparatus having a low priority degree is neglected according to the interrupt signal. In this example, operation performed when the interrogator apparatus 1 has a higher priority degree than the interrogator apparatus 2 is explained.

As shown in FIG. 9A and 9B, the interrogator apparatus 1 originates an unmodulated signal (CW). The interrogator apparatus 2 detects a carrier when the interrogator apparatus 2 performs carrier sense (CS). Therefore, the interrogator apparatus 2 may be unable to transmit a radio signal to the radio tag. This is because interference occurs if the interrogator apparatus 2 transmits a radio signal.

Therefore, the interrogator apparatus 2 back-scatters the interrupt signal Interrupt by controlling the switching element 9.

The interrogator apparatus 1 compares a priority degree in Interrupt and the priority degree of the interrogator apparatus 1 stored in the priority degree table 38. If the priority degree of the interrogator apparatus 1 is higher than the priority degree in Interrupt, the interrogator apparatus 1 neglects the interrupt signal and continues communication with the radio tag.

The interrogator apparatus 2 performs the carrier sense again after transmitting Interrupt. However, since a radio signal is transmitted from the interrogator apparatus 1, the interrogator apparatus 2 may be unable to transmit a radio signal.

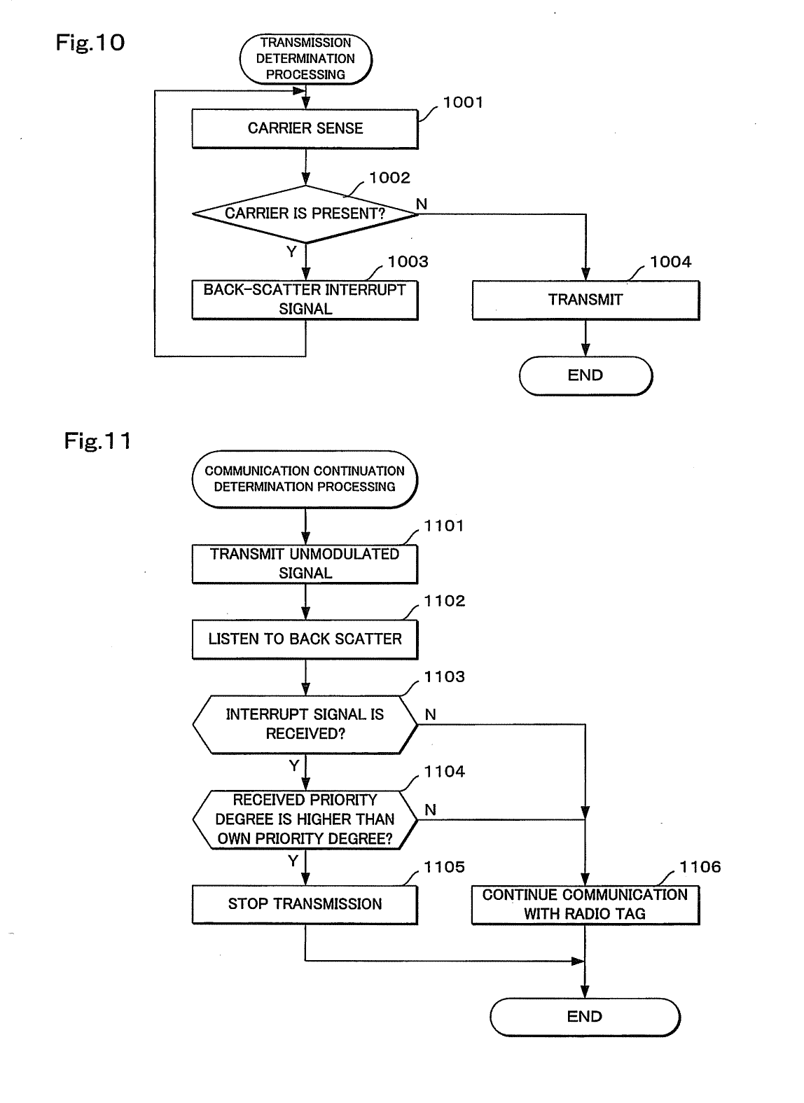

FIG. 10 is a flowchart for explaining the operation of transmission determination processing by the interrogator apparatus. As shown in FIG. 10, in Act 1001, the interrogator apparatus performs carrier sense.

In Act 1002, the interrogator apparatus determines whether a carrier is present. If the interrogator apparatus determines that a carrier is present, the interrogator apparatus proceeds to Act 1003. If the interrogator apparatus determines that a carrier is absent, the interrogator apparatus proceeds to Act 1004.

In Act 1003, the interrogator apparatus back-scatters an interrupt signal.

In Act 1004, the interrogator apparatus transmits a radio signal to the radio tag.

FIG. 11 is a flowchart for explaining the operation of communication continuation determination processing by the interrogator apparatus. As shown in FIG. 11, in Act 1101, the interrogator apparatus transmits an unmodulated signal.

In Act 1102, the interrogator apparatus listens, i.e., detects whether back scatter is performed.

In Act 1103, the interrogator apparatus determines whether an interrupt signal is received. If the interrogator apparatus determines that an interrupt signal is received, the interrogator apparatus proceeds to Act 1104. If the interrogator apparatus determines that an interrupt signal is not received, the interrogator apparatus proceeds to Act 1106.

In Act 1104, the interrogator apparatus determines whether a priority degree included in the received interrupt signal is higher than a priority degree of the interrogator apparatus. If the interrogator apparatus determines that the priority degree included in the received interrupt signal is higher than the priority degree of the interrogator apparatus, the interrogator apparatus proceeds to Act 1105. If the interrogator apparatus determines that the priority degree included in the received interrupt signal is not higher than the priority degree of the interrogator apparatus, the interrogator apparatus proceeds to Act 1106.

In Act 1105, the interrogator apparatus stops transmission of a radio signal.

In Act 1106, the interrogator apparatus continues communication with the radio tag.

As explained above, the interrogator apparatus according to this embodiment includes the transmitting section 33 configured to generate a transmission signal, the receiving section 34 configured to process a reception signal, the antenna 11 configured to transmit and receive a radio signal, the directional coupler 8 configured to supply the transmission signal from the transmitting section 33 to the antenna 11 and supply the reception signal from the antenna 11 to the receiving section 34, the switching element 9, the first terminal A of which is connected to the directional coupler 8 and the second terminal B of which is grounded, the switching element 9 connecting the first terminal A or the second terminal B to the antenna 11 according to the control signal from the control section 1, and the control section 1 configured to control, when performing carrier sense and detecting a carrier, the switching element 9 to back-scatter an interrupt signal and stop transmission of a radio signal to another interrogator apparatus having a lower priority degree than the interrogator apparatus.

Therefore, there is an effect that, even if plural interrogator apparatuses are simultaneously operated, interference of radio signals does not occur and it is possible to allow an interrogator apparatus desired to be preferentially used to perform radio communication in preference to the other interrogator apparatuses.

### SECOND EMBODIMENT

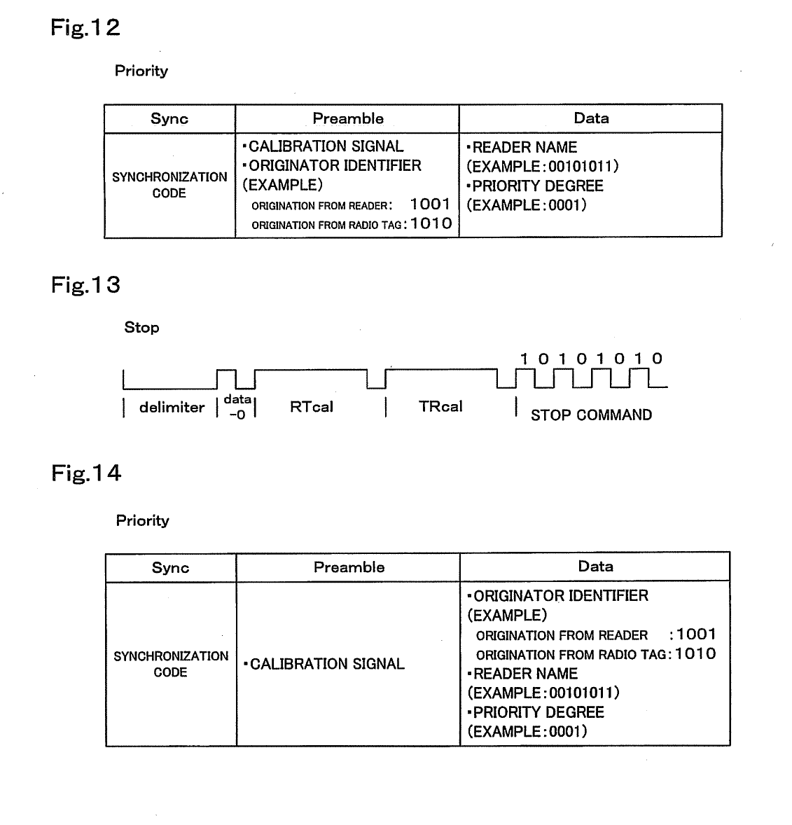

FIG. 12 is a diagram of a first example of a priority signal transmitted by the interrogator apparatus according to an AM modulation signal.

As shown in FIG. 12, a priority signal Priority includes Sync, Preamble, and Data.

Sync is a synchronization code. Preamble includes a calibration signal and an originator identifier for identifying an originator of a signal.

The originator identifier indicates whether a received back-scatter signal is a signal from the radio tag or a signal from another interrogator apparatus. For example, if a signal is originated from the interrogator apparatus, “1001” indicating “origination from a reader” can be adopted as the originator identifier. If a signal is originated from the radio tag, “1010” indicating “origination from the radio tag” can be adopted as the originator identifier.

According to the originator identifier, if a received signal is a signal from the radio tag, the interrogator apparatus can perform normal radio communication and, if the received signal is a signal from another interrogator apparatus, the interrogator apparatus can recognize that the signal is an interrupt signal.

The structure of Preamble is the same as the structure of Preamble in the first example of the first embodiment.

Data includes “reader name” indicating an originator interrogator apparatus and “priority degree” indicating a priority degree of the originator interrogator apparatus.

FIG. 13 is a diagram of an example of a stop signal transmitted by the interrogator apparatus using back scatter.

As shown in FIG. 13, Preamble of a stop signal Stop includes delimiter indicating the start of a signal, data-0 for calibrating data length, RTcal for calibration of a radio signal from the interrogator apparatus to the radio tag, TRcal for calibration of a radio signal from the radio tag to the interrogator apparatus, and a Stop command.

The interrogator apparatus that receives the stop signal stops the transmission of a radio signal. Therefore, when plural interrogator apparatuses are operating, if a certain interrogator apparatus emits the stop signal, all the other interrogator apparatuses stop the transmission of radio signals.

FIG. 14 is a diagram of a second example of the priority signal transmitted by the interrogator apparatus according to the AM modulation signal.

As shown in FIG. 14, an interrupt signal Interrupt includes Sync, Preamble, and Data.

Sync is a synchronization code. Preamble includes a calibration signal.

Data includes an originator identifier for identifying an originator of a signal, “reader name” indicating an originator interrogator apparatus, and “priority degree” indicating a priority degree of the originator interrogator apparatus.

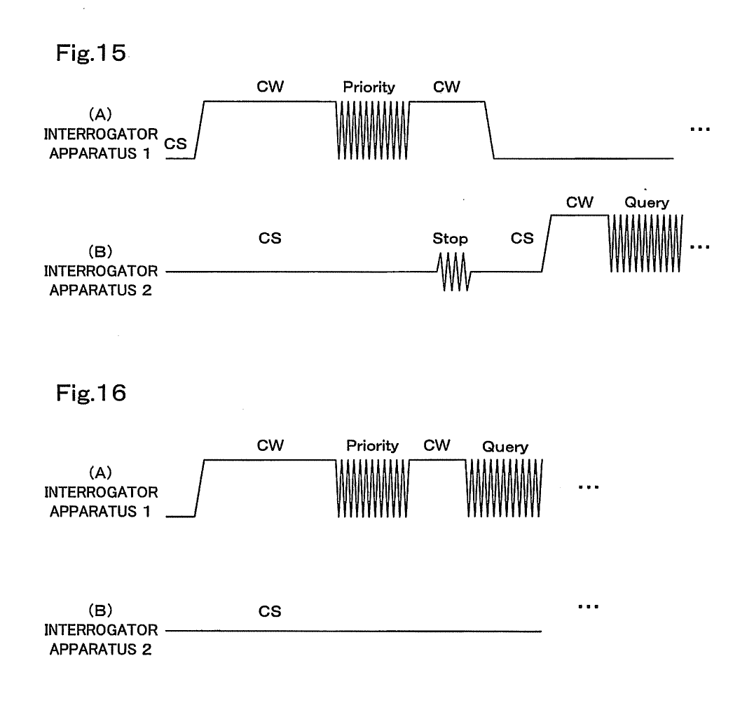

FIGS. 15A and 15B are timing charts for explaining an example in which an interrogator apparatushaving a high priority degree is given priority according to a priority signal and a stop signal. In this example, operation performed when the interrogator apparatus 2 has a higher priority degree than the interrogator apparatus 1 is explained.

As shown in FIG. 15A and 15B, when the interrogator apparatus 1 performs carrier sense and does not detect a carrier, the interrogator apparatus 1 starts transmission of a radio signal for communication with the radio tag. In the communication with the radio tag, the interrogator apparatus 1 periodically transmits a priority signal.

The interrogator apparatus 2 performs carrier sense. However, since the interrogator apparatus 1 is transmitting the radio signal, the interrogator apparatus 2 may be unable to transmit a radio signal.

The interrogator apparatus 2 determines whether a priority degree included in the received priority signal is lower than a priority degree of the interrogator apparatus 2. If the interrogator apparatus 2 determines that the priority degree included in the received priority signal is lower than the priority degree of the interrogator apparatus 2, the interrogator apparatus 2 back-scatters an unmodulated signal of the interrogator apparatus 1 and transmits a stop signal.

If the interrogator apparatus 1 receives the stop signal, the interrogator apparatus 1 stops the transmission of the radio signal.

The interrogator apparatus 2 performs carrier sense and confirms that a carrier is absent. Then, the interrogator apparatus 2 transmits Query and starts communication with the radio tag.

FIGS. 16A and 16B are timing charts for explaining an example in which an interrogator apparatus having a low priority degree is silenced according to the priority signal and the stop signal. In this example, operation performed when the interrogator apparatus 1 has a higher priority degree than the interrogator apparatus 2 is explained.

As shown in FIG. 16A and 16B, when the interrogator apparatus 1 performs carrier sense and does not detect a carrier, the interrogator apparatus starts transmission of a radio signal for communication with a radio tag. In the communication with the radio tag, the interrogator apparatus 1 periodically transmits a priority signal.

The interrogator apparatus 2 performs carrier sense. However, since the interrogator apparatus 1 is transmitting the radio signal, the interrogator apparatus 2 may be unable to transmit a radio signal.

The interrogator apparatus 2 determines whether a priority degree included in the received priority signal is higher than the priority degree of the interrogator apparatus 2. If the interrogator apparatus 2 determines that the priority degree included in the received priority signal is higher than the priority degree of the interrogator apparatus 2, the interrogator apparatus 2 keeps silence without emitting a radio signal.

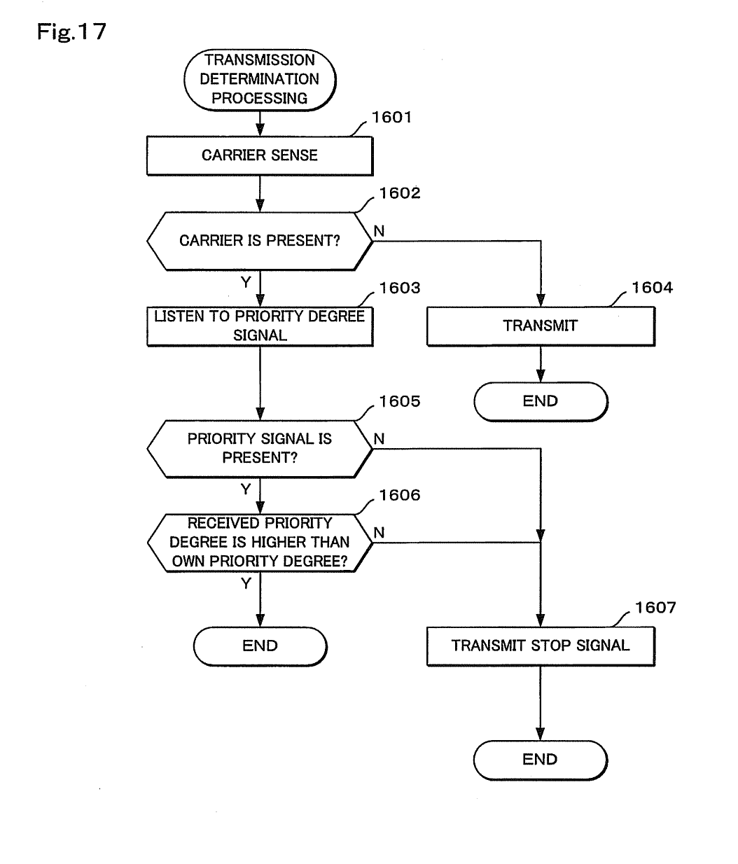

FIG. 17 is a flowchart for explaining the operation of transmission determination processing by the interrogator apparatus. As shown in FIG. 17, in Act 1601, the interrogator apparatus performs carrier sense.

In Act 1602, the interrogator apparatus determines whether a carrier is present. If the interrogator apparatus determines that a carrier is present, the interrogator apparatus proceeds to Act 1603. If the interrogator apparatus determines that a carrier is absent, the interrogator apparatus proceeds to Act 1604.

In Act 1603, the interrogator apparatus listens to a priority degree signal.

In Act 1604, the interrogator apparatus transmits a radio signal in order to start communication with the radio tag and ends the processing.

In Act 1605, the interrogator apparatus determines whether a priority signal is present in a reception signal. If a priority signal is present in the reception signal, the interrogator apparatus proceeds to Act 1606. If a priority signal is absent, the interrogator apparatus proceeds to Act 1607.

In Act 1606, the interrogator apparatus determines whether a priority degree included in the priority signal is higher than a priority degree of the interrogator apparatus. If the interrogator apparatus determines that the priority degree included in the priority signal is higher than the priority degree of the interrogator apparatus, the interrogator apparatus ends the processing. If the interrogator apparatus determines that the priority degree included in the priority signal is not higher than the priority degree of the interrogator apparatus, the interrogator apparatus proceeds to Act 1607.

In Act 1607, the interrogator apparatus transmits a stop signal, stops transmission of a radio signal by another interrogator apparatus, and ends the processing.

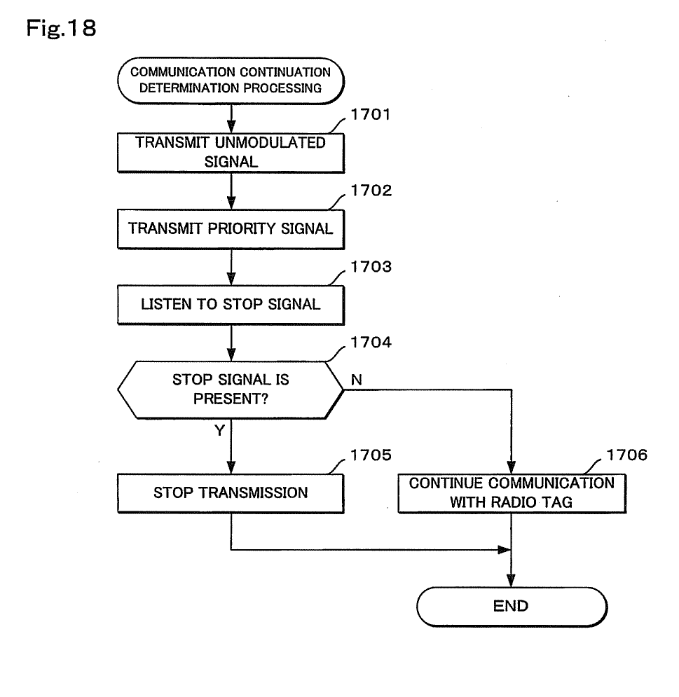

FIG. 18 is a flowchart for explaining the operation of communication continuation determination processing by the interrogator apparatus. As shown in FIG. 18, in Act 1701, the interrogator apparatus transmits an unmodulated signal.

In Act 1702, the interrogator apparatus transmits a priority signal.

In Act 1703, the interrogator apparatus listens to a stop signal.

In Act 1704, the interrogator apparatus determines whether a stop signal is present in a reception signal. If a stop signal is present in the reception signal, the interrogator apparatus proceeds to Act 1705 and stops transmission of a radio signal. If a stop signal is absent in the reception signal, the interrogator apparatus proceeds to Act 1706 and continues communication with the radio tag.

As explained above, the interrogator apparatus according to this embodiment includes the transmitting section 33 configured to generate a transmission signal, the receiving section 34 configured to process a reception signal, the antenna 11 configured to transmit and receive a radio signal, the directional coupler 8 configured to supply the transmission signal from the transmitting section 33 to the antenna 11 and supply the reception signal from the antenna 11 to the receiving section 34, the switching element 9, the first terminal A of which is connected to the directional coupler 8 and the second terminal B of which is grounded, the switching element 9 connecting the first terminal A or the second terminal B to the antenna 11 according to the control signal from the control section 1, and the control section 1 configured to control, if a priority degree of a received priority signal is lower than a priority degree of the interrogator apparatus, the switching element 9 to back-scatter a stop signal and cause another interrogator apparatus having a lower priority degree than the interrogator apparatus to stop transmission of a radio signal.

Therefore, there is an effect that, even if plural interrogator apparatuses are simultaneously operated, interference of radio signals does not occur and it is possible to allow an interrogator apparatus desired to be preferentially used to perform radio communication in preference to the other interrogator apparatuses. Further, since a stop signal is transmitted using a priority signal as a trigger, there is an effect that a protocol is not disordered.

### Communication Program

A computer program for executing the operation explained above is recorded in a computer-readable recording medium. The interrogator apparatus reads out the computer program from the recording medium and executes the computer program.

Examples of the computer-readable recording medium include a flexible magnetic disk, a hard disk, a flash memory, a magnetic tape, a memory such as a ROM, and an ASIC. However, the computer-readable recording medium is not limited to these.

While certain embodiments have been described, these embodiments have been presented by way of example only, and are not intended to limit the scope of the inventions. Indeed, the novel methods and apparatuses described herein may be embodied in a variety of other forms; furthermore, various omissions, substitutions and changes in the form of the methods and systems described herein may be made without departing from the spirit of the inventions. The accompanying claims and their equivalents are indeed to cover such forms or modifications as would fall within the scope and spirit of the inventions.

What is claimed is:

1. An interrogator apparatus comprising:
a transmitting section configured to generate a transmission signal;
a receiving section configured to process a reception signal;
an antenna configured to transmit and receive a radio signal;
a directional coupler configured to supply the transmission signal from the transmitting section to the antenna and supply the reception signal from the antenna to the receiving section; and
a switching element, a first terminal of which is connected to the directional coupler and a second terminal of which is grounded, the switching element switching, according to a control signal, whether the antenna is ground.

2. The apparatus according to claim 1, wherein the first terminal of the switching element is connected to the directional coupler, the second terminal of the switching element is grounded, and the switching element connecting the first terminal or the second terminal to the antenna according to the control signal.

3. The apparatus according to claim 1, further comprising a control section including a priority degree table that stores a priority degree of each interrogator apparatus and configured to generate a control signal for controlling the switching element, wherein
if the control section performs carrier sense and detects a carrier, the control section controls the switching element to back-scatter an interrupt signal and causes another interrogator apparatus having a lower priority degree than the interrogator apparatus to stop transmission of a radio signal.

4. The apparatus according to claim 3, wherein the control section includes, in the interrupt signal, an originator identifier indicating whether a signal originator is the interrogator apparatus and back-scatters the interrupt signal.

5. The apparatus according to claim 4, wherein the control section includes, in the interrupt signal, a name peculiarly allocated to the each interrogator apparatus and the priority degree, and back-scatters the interrupt signal.

6. The apparatus according to claim 5, wherein the control section includes the originator identifier in Preamble of the interrupt signal and back-scatters the interrupt signal.

7. The apparatus according to claim 1, further comprising a control section including a priority degree table that stores a priority degree of each interrogator apparatus and configured to generate a control signal for controlling the switching element, wherein
if a priority degree of a priority signal received from another interrogator apparatus is lower than a priority degree of the interrogator apparatus, the control section controls the switching element to back-scatter a stop signal and causes the other interrogator apparatus having the lower priority degree than the interrogator apparatus to stop transmission of a radio signal.

8. The apparatus according to claim 7, wherein the control section includes, in the priority signal, an originator identifier indicating whether a signal originator is the interrogator apparatus and transmits the priority signal by radio.

9. The apparatus according to claim 8, wherein the control section includes, in the priority signal, a name peculiarly allocated to the each interrogator apparatus and the priority degree, and transmits the priority signal by radio.

10. The apparatus according to claim 9, wherein the control section includes the originator identifier in Preamble of the priority signal and transmits the priority signal by radio.

11. A communication method for an interrogator apparatus including:
controlling a switching element of the interrogator apparatus to back-scatter a radio signal from another interrogator apparatus by switching the switching element according to a control signal, whether the antenna is grounded.

12. The method according to claim 11, wherein a first terminal of the switching element is connected to a directional coupler, a second terminal of the switching element is grounded, and the switching element connecting the first terminal or the second terminal to an antenna according to the control signal.

13. The method according to claim 11, further comprising controlling, if carrier sense is performed and a carrier is detected, the switching element to back-scatter an interrupt signal and causing the other interrogator apparatus having a lower priority degree than the interrogator apparatus to stop transmission of a radio signal.

14. The method according to claim 11, further comprising controlling, if a priority degree of a priority signal received from the other interrogator apparatus is lower than a priority degree of the interrogator apparatus, the switching element to back-scatter a stop signal and causing the other interrogator apparatus having the lower priority degree than the interrogator apparatus to stop transmission of a radio signal.

15. The method according to claim 13, further comprising including, in the priority signal, an originator identifier indicating whether a signal originator is the interrogator apparatus and transmitting the priority signal by radio.

16. A computer-readable medium having instructions configured to perform a communication method for an interrogator apparatus including: a transmitting section configured to generate a transmission signal; a receiving section configured to process a reception signal; an antenna configured to transmit and receive a radio signal; a directional coupler configured to supply the transmission signal from the transmitting section to the antenna and supply the reception signal from the antenna to the receiving section; and a switching element, a first terminal of which is connected to the directional coupler and a second terminal of which is grounded, the switching element switches, according to a control signal, whether the antenna is grounded,
the method comprising controlling the switching element of the interrogator apparatus to back-scatter a radio signal from another interrogator apparatus.

17. The medium according to claim 16, wherein the first terminal of the switching element is connected to the directional coupler, the second terminal of the switching element is grounded, and the switching element connecting the first terminal or the second terminal to the antenna according to the control signal.

18. The medium according to claim 16, wherein the method further comprises controlling, if carrier sense is performed and a carrier is detected, the switching element to back-scatter an interrupt signal and causing the other interrogator apparatus having a lower priority degree than the interrogator apparatus to stop transmission of a radio signal.

19. The medium according to claim 16, wherein the method further comprises controlling, if a priority degree of a priority signal received from the other interrogator apparatus is lower than a priority degree of the interrogator apparatus, the switching element to back-scatter a stop signal and causing the other interrogator apparatus having the lower priority degree than the interrogator apparatus to stop transmission of a radio signal.

20. The medium according to claim 18, wherein the method further comprises including, in the priority signal, an originator identifier indicating whether a signal originator is the interrogator apparatus and transmitting the priority signal by radio.
